(19) United States
(12) Patent Application Publication
(10) Pub. No.: US 2022/0261088 A1
(43) Pub. Date: Aug. 18, 2022

(54) ARTIFICIAL REALITY PLATFORMS AND CONTROLS

(71) Applicant: Facebook Technologies, LLC, Menlo Park, CA (US)

(72) Inventors: Etienne PINCHON, Pasadena, CA (US); John Jacob BLAKELEY, Bothell, WA (US); Michal HLAVAC, Seattle, WA (US); Jasper STEVENS, London (GB)

(73) Assignee: Facebook Technologies, LLC, Menlo Park, CA (US)

(21) Appl. No.: 17/739,701

(22) Filed: May 9, 2022

Related U.S. Application Data
(60) Provisional application No. 63/248,752, filed on Sep. 27, 2021.
(60) Provisional application No. 63/243,763, filed on Sep. 14, 2021.
(60) Provisional application No. 63/239,521, filed on Sep. 1, 2021.
(60) Provisional application No. 63/239,513, filed on Sep. 1, 2021.
(60) Provisional application No. 63/239,503, filed on Sep. 1, 2021.

(51) Int. Cl. G06F 3/01; G06F 3/04815; G06F 3/0482

(52) U.S. Cl. CPC G06F 3/017; G06F 3/0482; G06F 3/04815; G06F 3/011

(57) ABSTRACT

The disclosed technology can perform application controls in response to recognizing particular gestures. The disclosed technology can provide a launcher with virtual objects displayed in categories (e.g., history, pinned favorites, people, and a search area). The disclosed technology can perform a clone and configure input pattern, which clones a source virtual object into one or more cloned virtual objects with alternate configuration properties. The disclosed technology can perform a page or peel input pattern, which allows users to page between grids of virtual objects and facilitates peeling items out of the grid. The disclosed technology can perform a clutter and clear input pattern, which can expand multiple elements into individual views, while clearing other virtual objects.

### CROSS REFERENCE TO RELATED APPLICATIONS

This application claims priority to U.S. Provisional Application Nos. 63/239,503 filed Sep. 1, 2021 and titled “Clone and Configure Virtual Object Manipulation in an Artificial Reality Environment,” 63/239,513 filed Sep. 1, 2021 and titled “Page or Peel Virtual Object Manipulation in an Artificial Reality Environment,” 63/239,521 filed Sep. 1, 2021 and titled “Clutter and Clear Virtual Object Manipulation in an Artificial Reality Environment,” 63/243,763 filed Sep. 14, 2021 and titled “Artificial Reality Application Switching Gestures,” and 63/248,752 filed Sep. 27, 2021 and titled “Launcher for an Artificial Reality System.” Each patent application listed above is incorporated herein by reference in their entireties.

### BACKGROUND

Artificial reality (XR) environments can be provided by a variety of systems, such as projectors, head mounted displays, “cave” systems, etc. Users can interact with an artificial reality environment such as by selecting objects, moving, rotating, resizing, actuating controls, changing colors or skins, defining interactions between virtual objects, setting virtual forces to act on virtual objects, or practically any other imaginable action.

Different applications can completely control an artificial reality environment and/or write content into a shared artificial reality environment. Further, various interaction modalities exist for taking such actions in relation to an application in an artificial reality environment. For example, some systems can employ one or more of gaze controls, hand-held hardware devices, gesture controls, wearable devices (e.g., wrist bands), voice controls, etc. In some cases a user operating in an artificial reality environment can access controls for a current application and close it or access a list of applications on the artificial reality device and search for one the user wants to access.

Interaction with computing systems are often founded on a set of core concepts that define how users can interact with that computing system. For example, early operating systems provided textual interfaces to interact with a file directory. This was later built upon with the addition of “windowing” systems whereby levels in the file directory and executing applications were displayed in multiple windows, each allocated a portion of a 2D display that was populated with content selected for that window (e.g., all the files from the same level in the directory, a graphical user interface generated by an application, menus or controls for the operating system, etc.). As computing form factors decreased in size and added integrated hardware capabilities (e.g., cameras, GPS, wireless antennas, etc.) the core concepts again evolved, moving to an “app” focus where each app encapsulated a capability of the computing system.

Existing artificial reality systems provide models, such as 3D virtual objects and 2D panels, with which a user can interact in 3D space. Existing artificial reality systems have generally backed these models by extending the app core computing concept. For example, a user can instantiate these models by activating an app and telling the app to create the model, and using the model as an interface back to the app. This approach generally requires simulating, in the virtual space, the types of interactions traditionally performed with mobile devices and requires continued execution of the app for the models to persist in the artificial reality environment. Furthermore, this approach makes accessing objects difficult as they are tethered to instantiation from an application, which adds an inefficient and unintuitive way to access objects that act more like real-word objects.

The introduction of artificial reality systems has provided the opportunity for further interaction model shifts. Artificial reality systems provide an artificial reality (XR) environment, allowing users the ability to experience different worlds, learn in new ways, and make better connections with others. Artificial reality systems such as head-mounted displays (e.g., smart glasses, VR/AR headsets), projection “cave” systems, or other computing systems can present an artificial reality environment to the user, who can interact with virtual objects in the environment. These artificial reality systems can track user movements and translate them into interactions with “virtual objects” (i.e., computer-generated object representations appearing in a virtual environment.) For example, an artificial reality system can track a user's hands, translating a grab gesture as picking up a virtual object.

### SUMMARY

Aspects of the present disclosure are directed to recognizing particular gestures mapped to switching between applications, and other application controls, with an artificial reality device.

Aspects of the present disclosure are also directed to a launcher for an artificial reality system that can provide quick access to items, even when those items are not automatically populated into an artificial reality environment. Some artificial reality systems generate virtual object items and place them in an artificial reality environment when the virtual objects are contextually relevant. For example, an artificial reality system may display a virtual object showing an ingredient list when the user is in a store looking at various items. Users may also be able to place items in their world, e.g., at a location where they typically want to interact with that item. As examples, a user may pin a work task list virtual object on her desk and may pin an avatar of her best friend on her coffee table where she typically sits to call that friend. However, in all these examples, objects are spatially displayed, which may make them difficult to access at times when they are not as contextually relevant or when the user desires to access them in an atypical circumstance. The launcher discussed herein makes items (e.g., 3D models, applications, avatars of people, etc.) accessible, even when they are not spatially presented by an artificial reality system. In various cases, the items can be presented in the launcher in various categories such as a history of items in order the user interacted with the items, favorites the user has pinned in the launcher, people in order the user has interacted with each person, and a search area through which a user can locate other items based on their associated meta-data.

Aspects of the present disclosure are further directed to an input system that facilitates manipulation of virtual objects, in an artificial reality environment, with a clone and configure input pattern. The clone and configure input pattern allows a user to make clones, of a source virtual object, with one or more configurable properties that can be set to change aspects of the cloned virtual object. For example, the configurable properties can control what data the virtual object displays, how the virtual object is sized or positioned, how the virtual object interacts with users and other objects, etc. In various implementations, the configurable properties can be set based on a user selection of the configuration property, a context of the virtual object (e.g., based on a property mapping that takes as a key to the mapping what is around the virtual object, where the virtual object is placed, who cloned the virtual object, etc.), or an interaction with another virtual object or artificial reality environment surface (e.g., for the other virtual object or surface paired with the cloned virtual object, a property with a type matching the type of the configurable property can be copied to the configurable property of the cloned virtual object).

Additionally, aspects of the present disclosure are directed to an input system that facilitates manipulation of virtual objects, in an artificial reality environment, with a page or peel input pattern. The page or peel input pattern allows a user to page through vertical and/or horizontal elements of a virtual object and peel the active element out of the virtual object, which then can be dropped in an open space to create a new virtual object or on another virtual object to perform an interaction with that other virtual object. For example, a virtual object can represent a collection of elements (such as photos), which may be organized into categories. Each category of elements can be grouped, and the various groups can be paged (e.g., switched between) vertically while the elements within each group can be paged horizontally. In some implementations, the collection of elements can be a single group which can be paged through either horizontally or vertically. The creator of any given virtual object can specify which elements are represented by a virtual object and how they are grouped (if at all) and how the elements are paged horizontally and vertically. In some cases, an input system can automatically define groupings, e.g., based on defined relationships among the elements.

Yet further aspects of the present disclosure are directed to an input system that facilitates manipulation of virtual objects, in an artificial reality environment, with a clutter and clear input pattern. The clutter and clear input pattern allows a user to expand the elements of a source virtual object, so they are arranged in a space (i.e., in a volume or on a surface) around the location of the source virtual object. This can include the source virtual object obtaining authorization to write into the surrounding space (e.g., by expanding itself or creating new virtual objects for its component elements), while clearing other virtual objects that may be in that space (e.g., hiding them, minimizing them, moving them to another space, etc.) While expanded, a user can interact with the virtual object's elements, such as to make selections, perform element edits, extract elements from the virtual object (e.g., perform a “peel” operation), etc. Once the user has completed her interactions with the virtual object elements (as indicated by an explicit user command or inferred from context) the elements can collapse back into the source virtual object and the other cleared virtual objects can be restored to their original display mode and/or position.

### BRIEF DESCRIPTION OF THE DRAWINGS

FIG. 1 is an example of an index pinch gesture causing activation of an application control menu.

FIG. 2 is an example of pulling the index pinch from example 100 in a manner to activate an application switcher carousel.

FIG. 3 is an example of a user interacting with an application switcher carousel.

FIG. 4 is an example 400 of pulling the index pinch from example in a manner to close a currently activate application.

FIG. 5 is an example of a middle pinch gesture causing toggling to a previous application.

FIG. 6 is a flow diagram illustrating a process used in some implementations for performing application controls in response to recognizing particular gestures.

FIG. 7 is an example of a lifecycle of an item being added to, and used from, a launcher.

FIG. 8 is an example of a history tab in a launcher.

FIG. 9 is an example of a people tab in a launcher.

FIG. 10 is an example of a search tab in a launcher.

FIG. 11 is a flow diagram illustrating a process used in some implementations for displaying a launcher and allowing item selections from the launcher.

FIG. 12 is an example of a selection of a source cloneable virtual object in an artificial reality environment.

FIG. 13 is an example of the creation of multiple clones of a selected source virtual object.

FIG. 14 is an example of the configuration of multiple clone virtual objects.

FIG. 15 is a flow diagram illustrating a process used in some implementations for performing a clone and configure input pattern.

FIG. 16 is an example of an artificial reality environment with virtual objects, including one configured for a page or peel input pattern.

FIG. 17 is an example of a virtual object configured for a horizontal only page or peel input pattern.

FIG. 18 is an example of a virtual object configured for a vertical only page or peel input pattern with a user performing a peel input.

FIG. 19 is a flow diagram illustrating a process used in some implementations for performing a page or peel input pattern.

FIG. 20 is an example of an artificial reality environment with multiple virtual objects, one of which configured for a clutter and clear input pattern.

FIG. 21 is an example of a virtual object expanded to show its multiple elements through the takeover of a surrounding volume.

FIG. 22 is an example of a virtual object expanded to show its multiple elements through the takeover of a surface.

FIG. 23 is a flow diagram illustrating a process used in some implementations for performing a clutter and clear input pattern.

FIG. 24 is a block diagram illustrating an overview of devices on which some implementations of the disclosed technology can operate.

FIG. 25 is a block diagram illustrating an overview of an environment in which some implementations of the disclosed technology can operate.

### DESCRIPTION

An artificial reality (XR) gesture engine can identify sequences of gestures mapped to application switching and closing to perform these actions. In some cases, the mapping can include a first gesture (e.g., a “middle pinch,” where a user makes a pinch between her thumb and middle finger) mapped to toggling to make active a previous application from a stack of recent applications. In some cases, the mapping can include a second gesture (e.g., an “index pinch,” where a user makes a pinch between her thumb and index finger) mapped to bringing up an application control menu. Further, while the application control menu is active, the mapping can include a third gesture (e.g., pulling the index pinch to a side at a rate above a threshold rate and at a distance above a threshold distance) mapped to closing a currently active application. Also while the application control menu is active, the mapping can include a fourth gesture (e.g., pulling the index pinch to a side at a rate below the threshold rate and at a distance below the threshold distance) mapped to opening an application switcher carousel in which a user can browse through the stack of recent applications and choose one to make active.

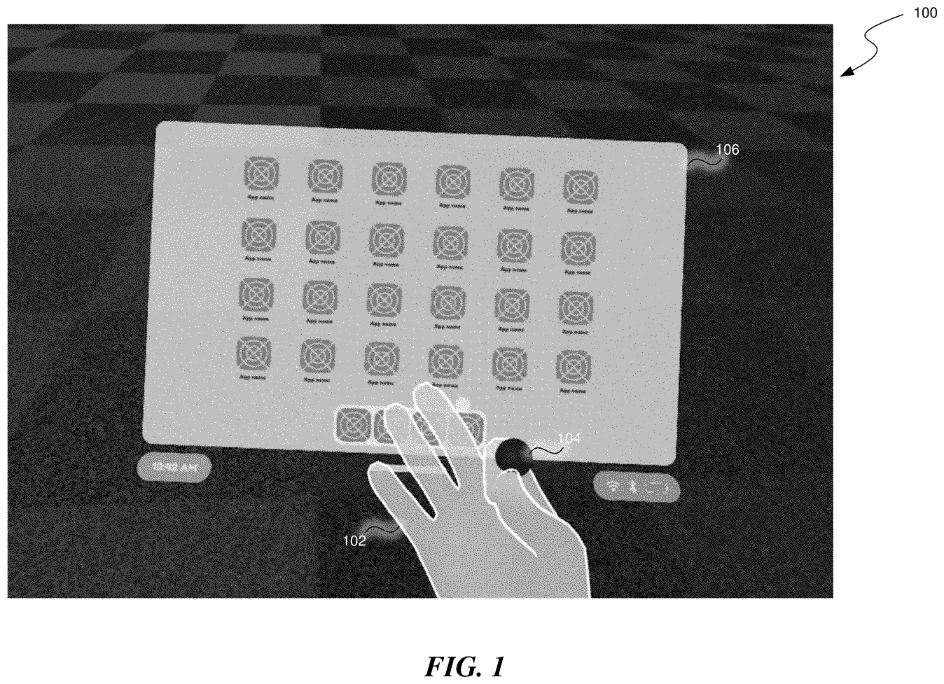

FIG. 1 is an example 100 of an index pinch gesture causing activation of an application control menu. In example 100, a user 102 has made an index pinch gesture (where the circle 104 illustrates the artificial reality device recognizing the connection of the user's thumb and index finger). In response to recognizing the index pinch gesture, an XR gesture engine can cause display of the application control menu 106, which lists available applications the user can select to activate.

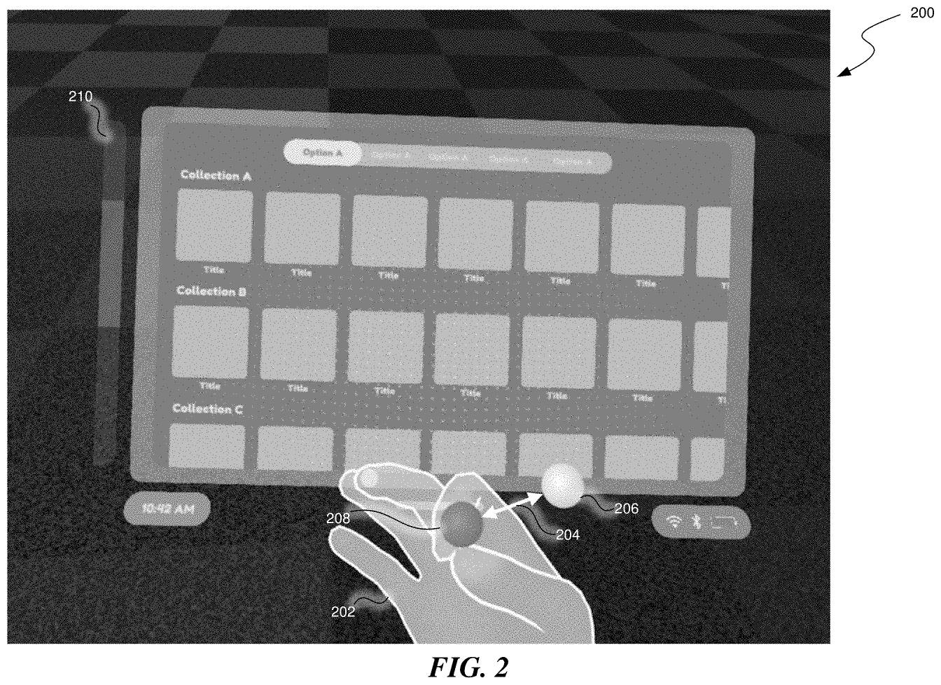

FIG. 2 is an example 200 of pulling the index pinch from example 100 in a manner to activate an application switcher carousel. In example 200, a user 202 has pulled the index pinch gesture by a distance 204 which is below a distance threshold (and at a velocity below a velocity threshold), where the distance 204 is from the position 206 where the index pinch was originally made to a current position 208. In response, the XR gesture engine has activated the application switcher carousel, a portion of which is shown at 210.

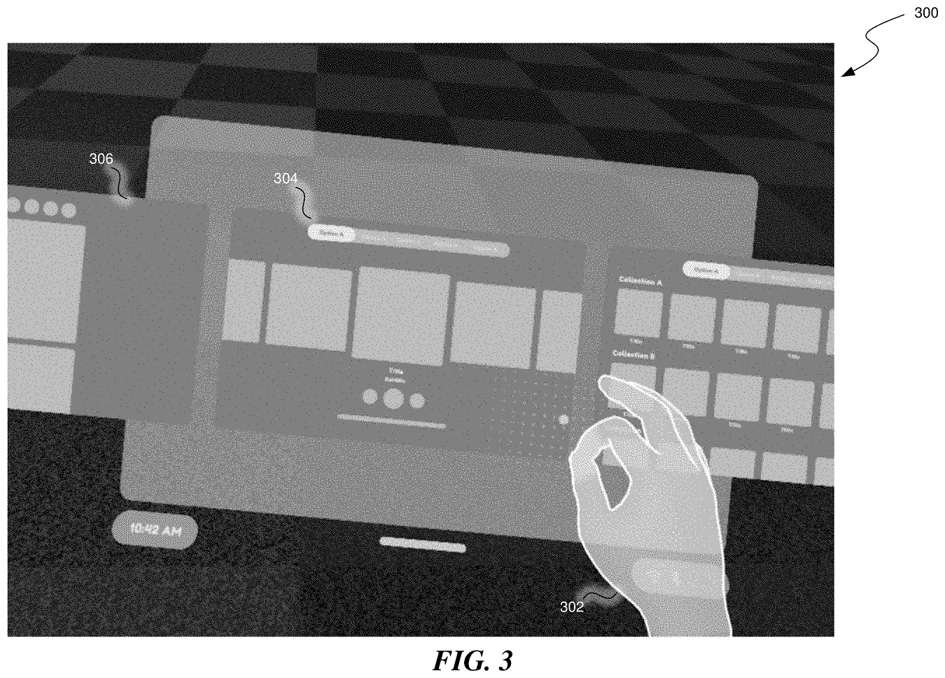

FIG. 3 is an example 300 of a user interacting with an application switcher carousel. The application switcher carousel allows a user 302 to page through a stack of recent or active applications (representations of which are shown as a snapshot—such as 304 and 306) to select one to activate and/or bring to the foreground of an artificial reality environment (e.g., by repeating pulling the index pinch gesture from example 200 and releasing the index pinch gesture when the snapshot of the desired application is presented).

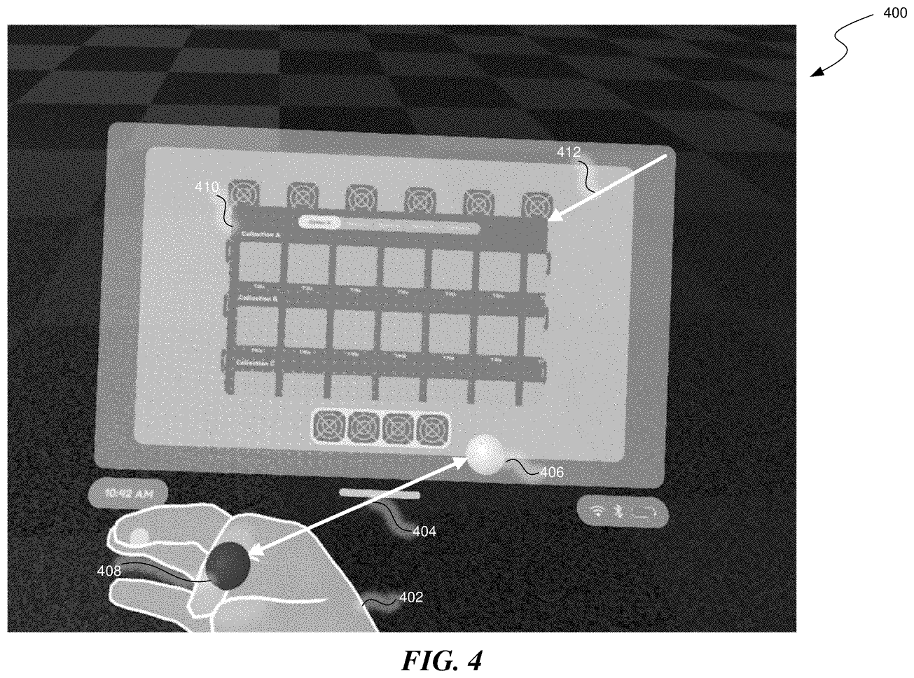

FIG. 4 is an example 400 of pulling the index pinch from example 400 in a manner to close a currently activate application. In example 400, a user 402 has pulled the index pinch gesture by a distance 404 which is above a distance threshold (and at a velocity above a velocity threshold), where the distance 404 is from the position 406 where the index pinch was originally made to a current position 408. In response, the XR gesture engine has begun closing the current application, with the frame 410 for the current application closing (as indicated by arrow 412).

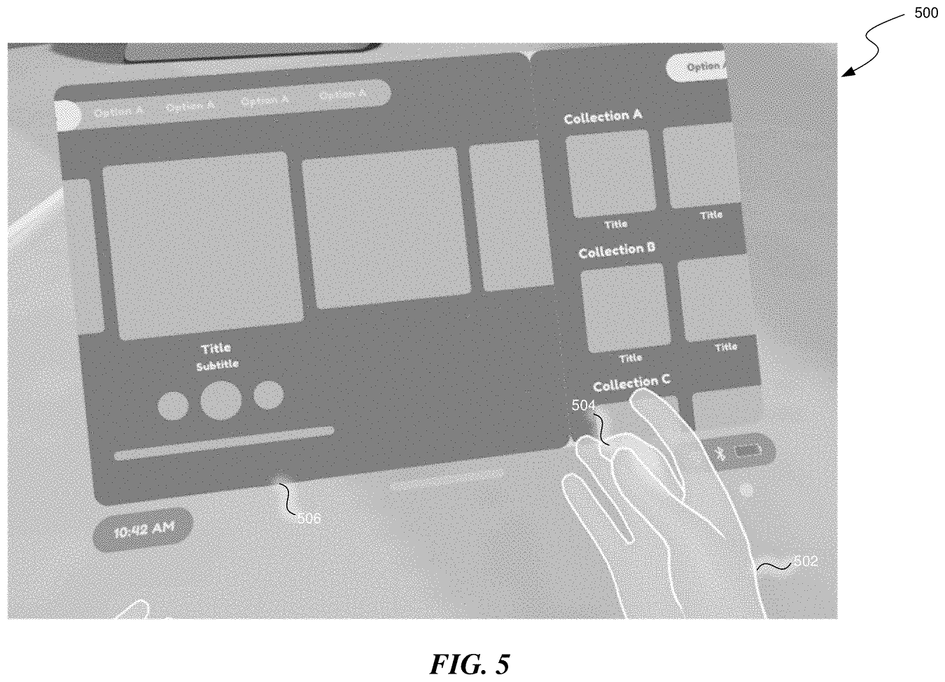

FIG. 5 is an example 500 of a middle pinch gesture causing toggling to a previous application. In example 500, a user 502 is performing middle pinch gesture 504. In response, the XR gesture engine accesses a data structure (e.g., a stack) storing recently active applications. The XR gesture engine makes active the most recent application 506 from the data structure (e.g., popping the top item from the stack).

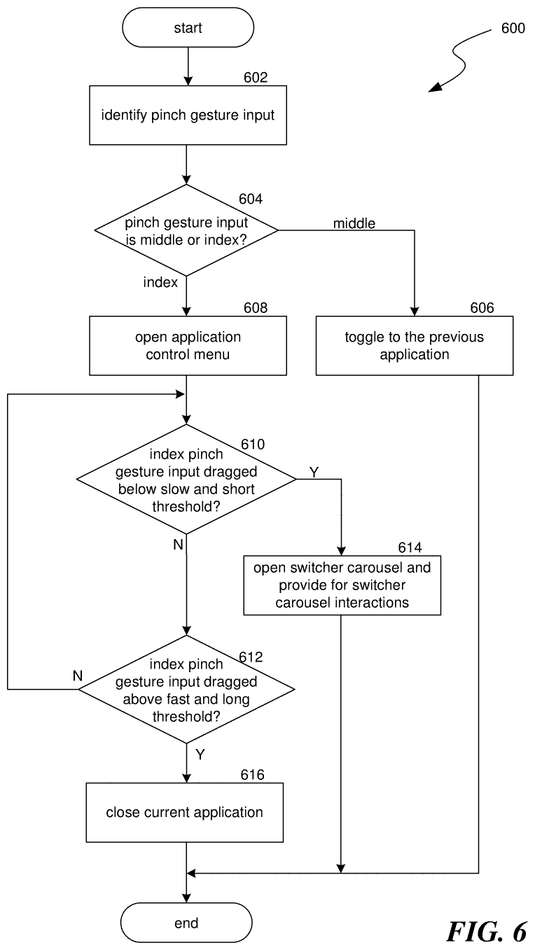

FIG. 6 is a flow diagram illustrating a process 600 used in some implementations for performing application controls in response to recognizing particular gestures. In some implementations, process 600 can be performed by an artificial reality device, e.g., under the control of an operating system, “shell” application, or third-party application that is providing an artificial reality environment via the artificial reality device. In some cases, process 600 can be performed in response to the artificial reality device being powered on or as part of the execution of the operating system, “shell” application, or third-party application.

At block 602, process 600 can identify a pinch gesture input. In some implementations, the artificial reality device performing process 600 can include motion and position tracking units, cameras, light sources, etc., which allow the artificial reality device to, e.g., track itself in 3DoF or 6DoF, track portions of the user (e.g., hands, feet, head, or other body parts), and have virtual objects react to gestures and other real-world objects. Hand postures can be identified using input from external facing cameras that capture depictions of user hands and/or hand postures can be based on input from a wearable device such as a glove or wristband that tracks aspects of the user's hands. In some implementations, input can be interpreted as postures mapped as certain gestures by applying the input to a machine learning model trained to identify hand postures and/or gestures based on such input. In some implementations, heuristics or rules can be used to analyze the input to identify hand postures and/or gestures. A pinch gesture can be recognized when the tip of a user's thumb is recognized as making contact with the tip of another finger on the same hand.

At block 604, process 600 can determine whether the gesture input is a middle pinch or an index pinch. A middle pinch gesture is where the user's thumb tip touches the tip of the user's middle finger, while an index pinch gesture is where the user's thumb tip touches the tip of the user's index finger. If the gesture is a middle pinch, process 600 can continue to block 606. If the gesture is an index pinch, process 600 can continue to block 608. If the gesture is neither a middle pinch nor an index pinch (not shown), process 600 can end to be repeated when a new pinch gesture is recognized.

At block 606, process 600 can, in response to the middle pinch gesture, toggle to the previous application. Toggling to the previous application can include accessing a data structure that stores which applications have recently been active, in order of their most recent activation or interaction by the user, and reactivates or brings up the most recent application. For example, the data structure can be a stack where applications are pushed to the top of the stack each time they are activated or accessed, and toggling to the previous application can include popping the top item off the stack (or the second item in the stack if the top item is currently active).

At block 608, process 600 can, in response to the index pinch gesture, open an application control menu. The application control menu can include user interface (UI) elements e.g., listing items from the data structure (described in block 606), listing applications stored on the artificial reality device, listing applications according to a rank specifying how likely the user is to want the application, listing applications the user has marked as a “favorite,” etc. The application control menu can provide controls to activate a given application, close an application, download components of an application, share an application with another user, etc.

At block 610, process 600 can identify whether the index pinch gesture input is dragged below a slow and short threshold and at block 612, process 600 can identify whether the index pinch gesture input is dragged above a fast and long threshold. These determinations can be based on further gesture recognition, as discussed in relation to block 602.

At block 614, process 600 can, in response to the index pinch gesture being dragged below the slow and short threshold, open an application switcher carousel and provide for interactions in the application switcher carousel. The application switcher carousel allows a user to page through a data structure (e.g., stack) of recent or active applications to select one to activate and/or bring to the foreground of an artificial reality environment. For example, a user can repeat pulling the index pinch gesture (below the threshold distance and speed) and release the index pinch gesture when the desired application is presented in the application switcher carousel.

At block 616, process 600 can, in response to the index pinch gesture being dragged above the fast and long threshold, close a current application. Following block 606, 614, or 616, process 600 can end until another pinch gesture is recognized, causing process 600 to repeat.

A launcher for an artificial reality system can provide access to various types of items that the artificial reality system may not otherwise automatically populate into the artificial reality environment. In various implementations, the items can include one or more of 3D models, applications, people, etc. Also in various implementations, the launcher can include categories of items including one or more of: a history category, a favorites or quick launch category, a people category, a search category, or others.

A history category can present items with which the user has most recently interacted and/or on which she has most recently focused her attention. A favorites or quick launch category can present items the user has specifically added to this category to later access. A people category can present people with whom the user has most recently and/or most often interacted. A search category can provide an interface for a user to enter search criteria which the artificial reality system can then use to show items with matching meta-data (e.g., labels, temporal data, person tags, etc.) In some implementations, the artificial reality system can cache items included in the launcher, allowing the artificial reality system to quickly instantiate them upon a user selection without having to wait for the artificial reality system to retrieve the item's components.

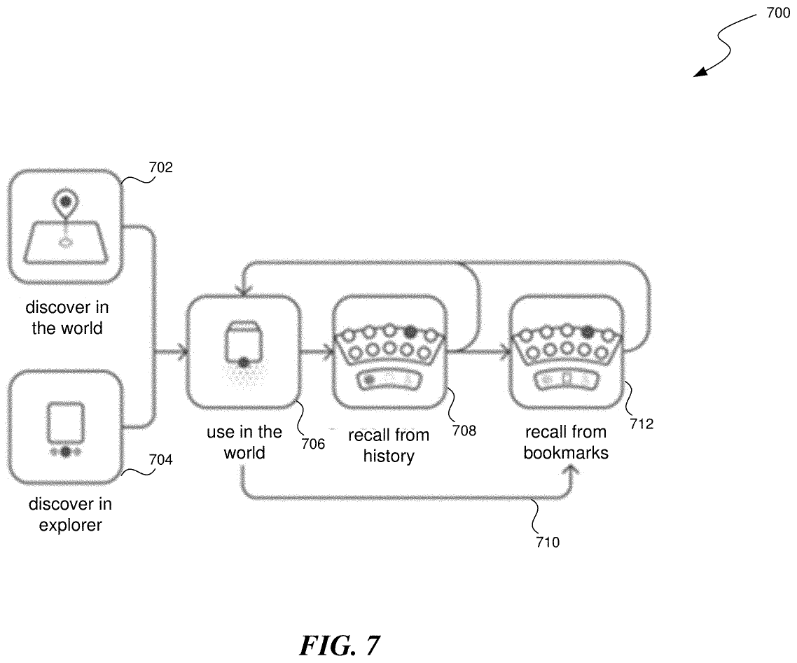

FIG. 7 is an example 700 of a lifecycle of an item being added to, and used from, a launcher. In example 700, an item can be added to a history section of the launcher either when it is discovered in the world (at 702) and the user interacts with it (at 706) or when it is discovered through a browser of items (at 704) and the user interacts with it (at 706). The user can then bring up the launcher and view the item in the launcher and pull it back into her artificial reality environment (at 708) or, if she has pinned it to a bookmarks section (at 710), can view the item in the launcher and pull it back into her artificial reality environment (at 712).

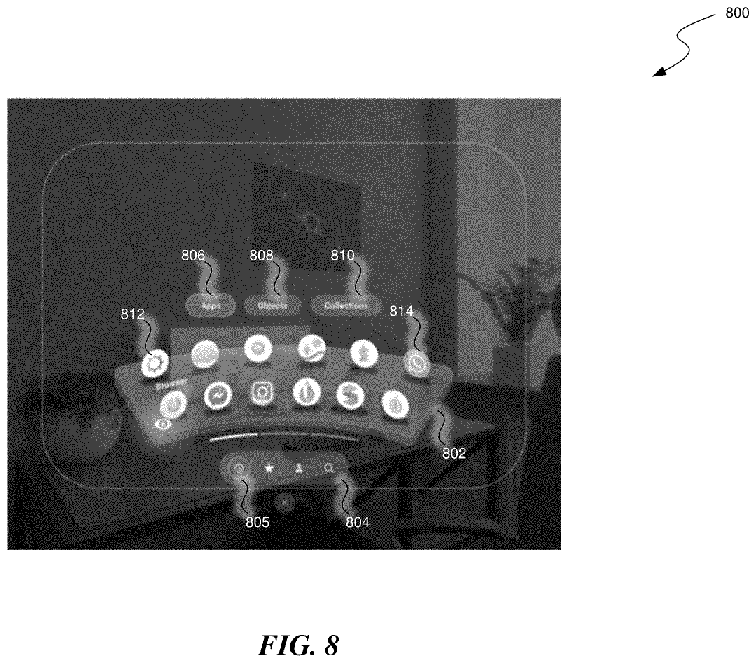

FIG. 8 is an example 800 of a history tab in a launcher. In example 800, the launcher 802 is being presented in an artificial reality environment, where the launcher includes categories 804 (history, favorites, people, and search). In example 800 the history category 805 is selected. Within the history category, the launcher has three sub-categories for types of items for which the launcher module tracks user interactions: Apps 806, Objects 808, and Collections 810. In example 800 the Apps sub-category is selected, showing application items which the user has most recently interacted, such as applications 812 and 814, in the selection area.

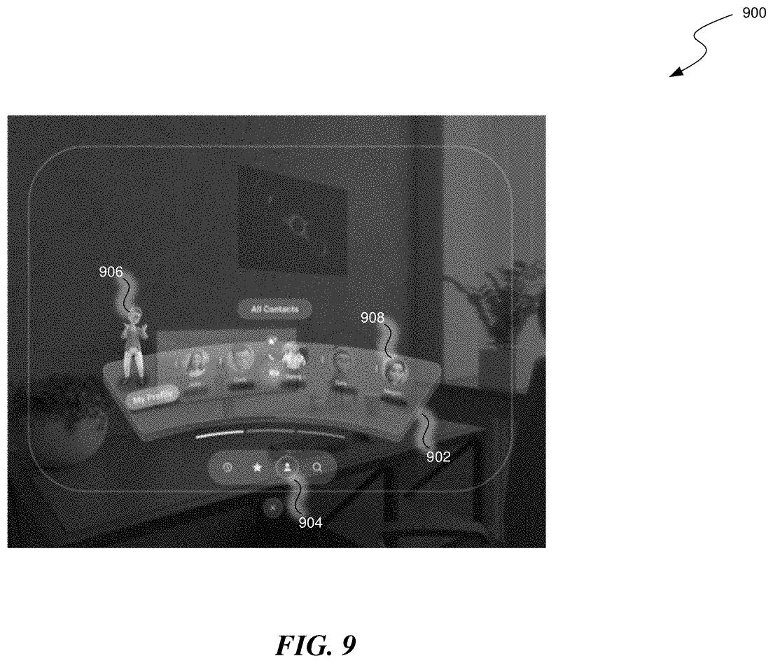

FIG. 9 is an example 900 of a people tab in a launcher. In example 900, the launcher 902 has the people category 904 selected. This shows items comprising representations of people that the user has most recently interacted with, that the user most often interacts with, or a combination of both, such as person representation 908. In example 900, the launcher 902 also includes a self-representation 906, providing the user access to view and edit her own profile.

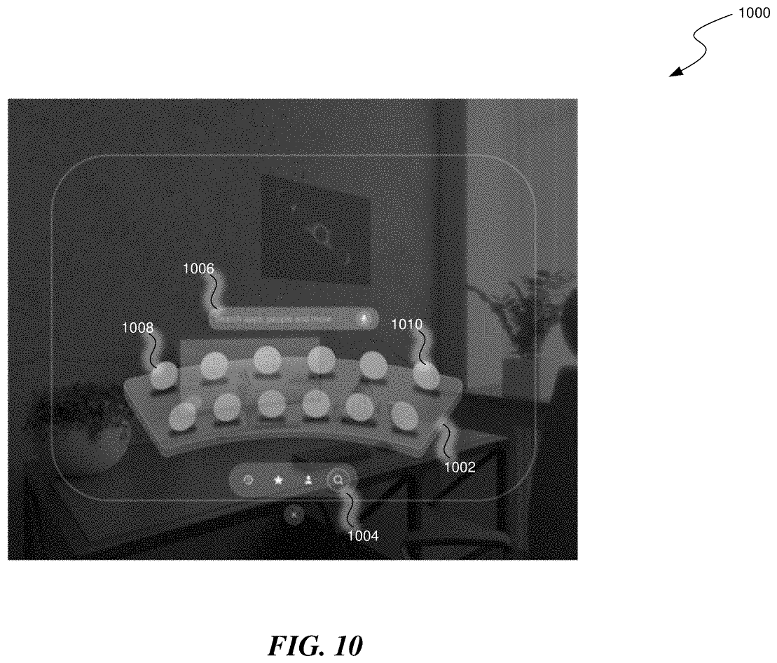

FIG. 10 is an example 1000 of a search tab in a launcher. In example 1000, the launcher 1002 has the search category 1004 selected. This shows a search bar 1006 into which the user can enter search terms. The launcher module can search through available items for those with meta data matching the search terms (e.g., for people names, object tags, application names, etc.) The launcher 1002 can display the matching items, such as items 1008 and 1010, for user selection.

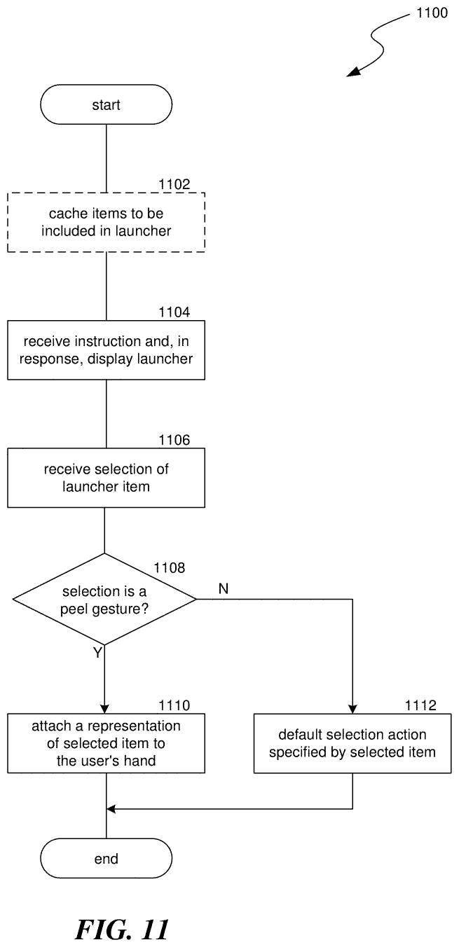

FIG. 11 is a flow diagram illustrating a process 1100 used in some implementations for displaying a launcher and allowing item selections from the launcher. In some implementations, process 1100 can be performed on an artificial reality device, e.g., as part of the artificial reality device operating system, a shell application in control of an artificial reality environment, or a third-party application writing to the artificial reality environment. In some cases, process 1100 can be performed as part of the initialization of the operating system, shell application, or third-party application.

At block 1102, process 1100 can cache items to be included in a launcher. While any block can be removed or rearranged in various implementations, block 1102 is shown in dashed lines to indicate there are specific instances where block 1102 is skipped. Caching items can allow the items to be quickly available to be brought into the artificial reality environment, without having to download the components of the item. Process 1100 can cache any or all the items that the launcher can display, as discussed below in relation to block 1104. In some implementations, process 1100 can have a set cache size and can cache the highest priority (e.g., those showing at the top of each launcher category) until the cache, with the given size, is full.

At block 1104, process 1100 can receive an instruction to display the launcher and, in response, can display the launcher. In various implementations, such an instruction can be provided through activation of a UI element (e.g., the user performing an air tap or focusing her gaze on UI control configured for displaying the launcher), through a voice command to activate the launcher, or through a gesture mapped to opening the launcher (e.g., a pinch gesture with the user's palm facing upward). In various implementations, displaying the launcher can display items such as virtual objects, applications, or people. In some cases, the launcher can be divided into various categories, such as items selected based on a history of things the user interacted with and/or things the user's intent was focused on (gazed at for threshold time, made gesture toward, touched, user placed in their world), people the user has interacted with, user-selected favorites, quick settings, and/or a search section for the user to locate additional items. The people category can display a list of people the user has most recently and/or most often interacted with, where an interaction can include one or more of messaging, been co-located, having an in-person conversation, etc. In some cases, process 1100 can keep log of object and people interactions, allowing process 1100 to populate the history and people categories such that more recent object and person interactions are displayed higher in these categories.

At block 1106, process 1100 can receive a selection of a launcher item. Such a selection can include selecting a category and then selecting an item within that category. In various implementations, the selection can be performed with a gesture (e.g., “grabbing” the item), pointing a ray at the item, directing the user's gaze at the item, speaking an identifier for the item, etc.

At block 1108, process 1100 can determine whether the selection is a peel action. A peel action can be when the user performs a gesture to grab the item or points a ray at the item to drag it out of the launcher. At block 1110, process 1100 can, in response to the peel action, attach a representation of the item to the user's hand to be dropped into the artificial reality environment. For example, if the user reached into the launcher and grabbed the item, process 1100 can create the representation to appear as if the user is simply pulling the item out of the launcher, which the user may then be able to drop into her artificial reality environment. In alternate embodiments, process 1100 can attached the representation to another element, such as the end of the ray used to perform the peel action.

At block 1112, in response to the action not being a peel action, process 1100 can take a default selection action specified by the item. In various implementations, the creator of an item can specify what will happen when the item is selected and/or the operating system of the artificial reality device can take default actions in relation to a selected item. For example, where the item is an application, the default action can be to execute the application and where the item is a representation of a person default actions can be to bring up a menu of actions that can be taken in relation to the person, message the person, see a message history with the person, etc.

An input system can facilitate a clone and configure input pattern by receiving a source virtual object selection; receiving a clone instruction for the source virtual object; cloning the source virtual object into one or more cloned virtual objects, according to the clone instruction; receiving a configuration instruction for the one or more cloned virtual objects; and applying the configuration instruction to the one or more cloned virtual objects. In various implementations, either or both the clone instruction and configuration instruction can be an activation of a control associated with a virtual object, a gesture performed by a user in relation to a selected virtual object, a voice command performed in relation to a virtual object, etc. In some cases, the configuration instruction can further be an inference by the input system, e.g., based on a context of a cloned virtual object (e.g., where it is placed, who provided the clone instruction, what other objects the virtual object interacts with, etc.) In various cases, the clone instruction can specify one or more of: how many clones to make, where to place the clones, and initial or default values for configuration settings. The configuration instruction can specify any value setup for the cloned virtual object, e.g., to configure what data the cloned virtual object displays, how the cloned virtual object is sized or positioned, how the cloned virtual object interacts with users and objects, etc. In some cases the configuration instruction may specify default values which a user can then override with a manual selection or through association of the cloned virtual object with another object, surface, or volume in the artificial reality environment.

As an example, a virtual object can exist in an artificial reality environment that is a virtual clock on a wall. The virtual clock can have a time zone property (e.g., set to pacific standard time). A user can select the virtual clock as a source virtual object and provide a clone instruction to create a clone virtual clock. Initially, clone virtual clock can have copied the time zone from the source virtual clock, but a user can select another time zone for the clone virtual clock, e.g., by selecting a new time zone from a time zone selection control or by dropping another virtual object onto the cloned virtual clock that has a time zone property, which can be copied to the cloned virtual clock.

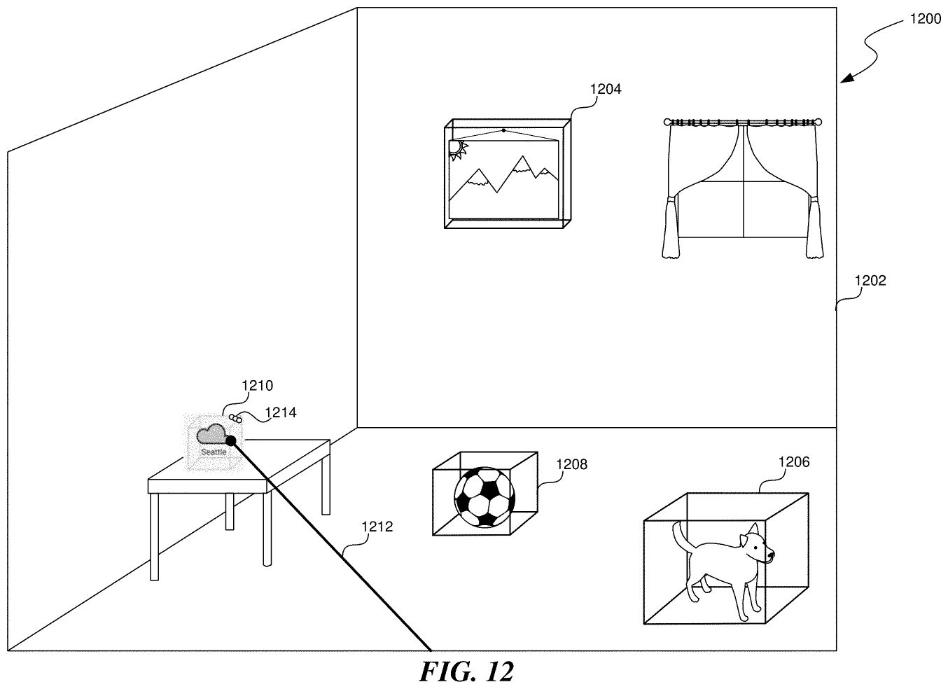

FIG. 12 is an example 1200 of a selection of a source cloneable virtual object in an artificial reality environment. Example 1200 includes an artificial reality environment 1202 that includes a number of virtual objects 1204-1210. A user, controlling a projected ray 1212, is selecting the virtual object 1210, which is a virtual object that shows weather information for a city specified as a configuration property. Upon the user selection, and because the selected virtual object can be cloned, a visual affordance 1214 is shown on the selected virtual object indicating it is cloneable and providing a control to initiate a clone instruction.

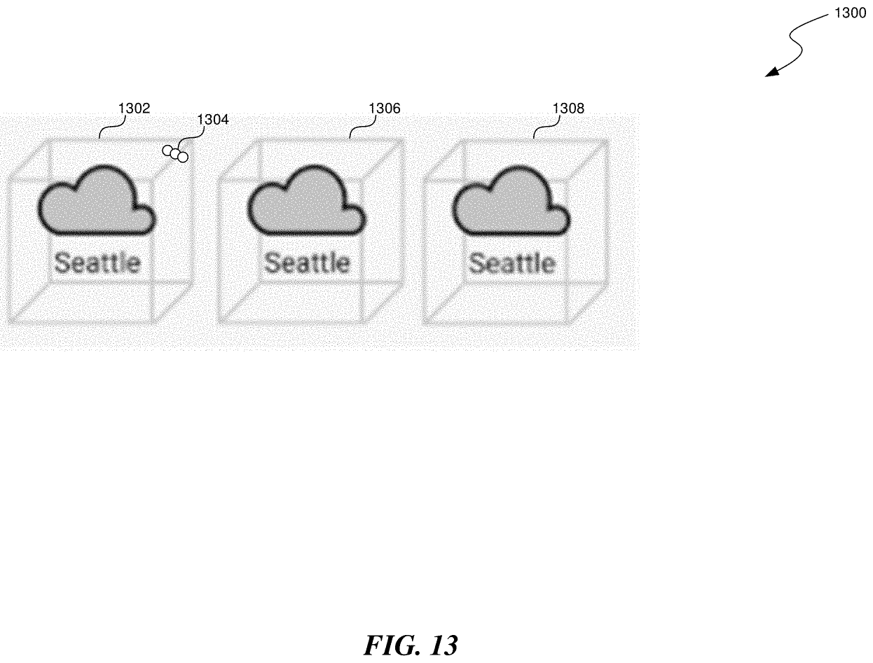

FIG. 13 is an example 1300 of the creation of multiple clones of a selected source virtual object. In example 1300, a user has provided a clone instruction by twice activating control 1304 on virtual object 1302. In response, the input system has created clone virtual objects 1306 and 1308 with the same internal properties as the source virtual object 1302 and automatically placed a threshold amount to the right (from the user's perspective) of the source virtual object 1302. Because the source virtual object 1302 is a virtual object providing weather information for the city Seattle, clone virtual objects 1306 and 1308 are also weather virtual objects providing weather information for the city Seattle.

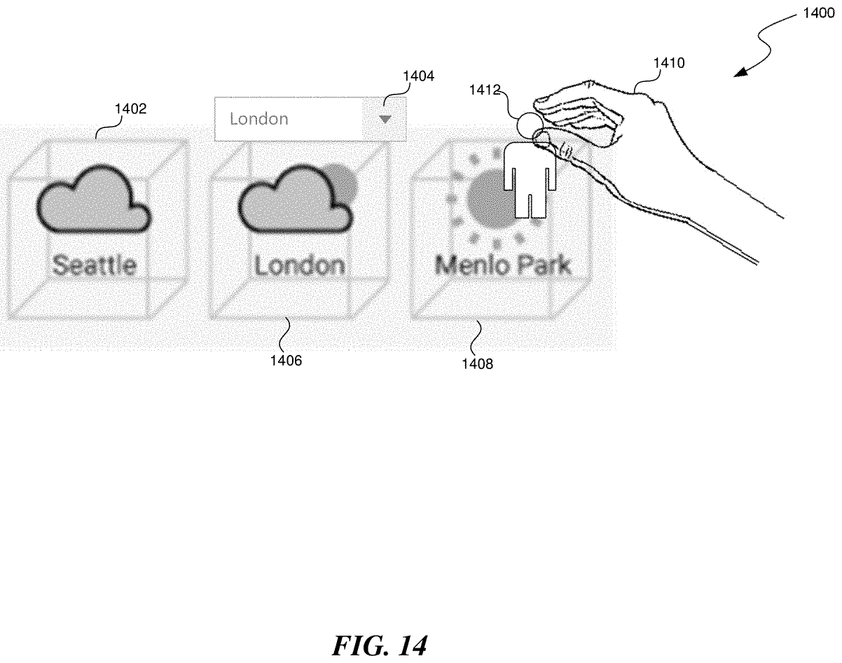

FIG. 14 is an example 1400 of the configuration of multiple clone virtual objects. In example 1400, source virtual object 1402 has been cloned to create cloned virtual objects 1406 and 1408. For cloned virtual object 1406, a user has provided a configuration instruction by using a city selection control 1404 to select London as the configuration property for the virtual object 1406, causing the virtual object 1406 to update itself to show weather information for the city of London. For cloned virtual object 1408, a user 1410 drops, as a configuration instruction, an avatar 1412 of a person on the virtual object 1408. Because the virtual object 1408 has a configuration property type of a city, and because person 1412 has a specified matching type of property (i.e., is specified as living in the city of Menlo Park), Menlo Park is set as the configuration property for the virtual object 1408 and virtual object 1408 updates itself to show weather information for the city of Menlo Park.

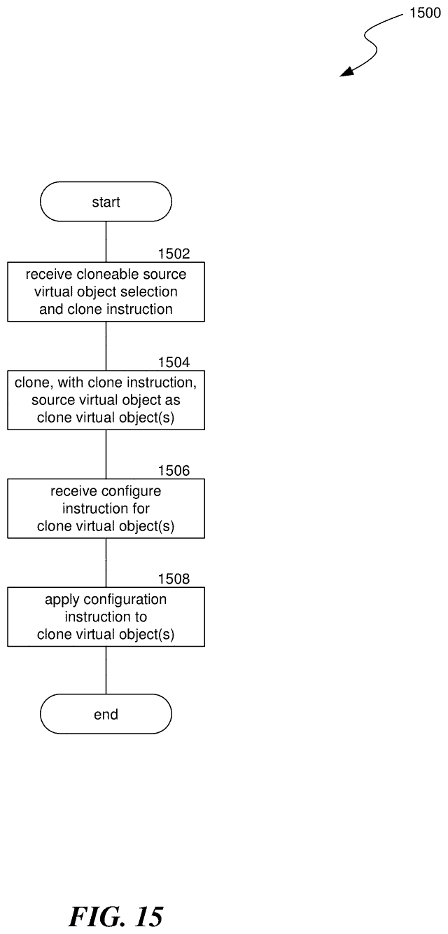

FIG. 15 is a flow diagram illustrating a process 1500 used in some implementations for performing a clone and configure input pattern. Process 1500 can be performed by an artificial reality device in control of an artificial reality environment, e.g., as part of the operating system of the artificial reality device, a “shell” application under the operating system in control of the artificial reality environment, or as part of another application executed in an artificial reality environment.

At block 1502, process 1500 can receive a selection of a cloneable source virtual object and a clone instruction for the source virtual object. In some cases, any virtual object can be cloneable, while in other implementations, certain virtual objects or virtual object types can be set as cloneable or not cloneable. When a virtual object is set as cloneable, it may specify which properties are to be update (the configuration properties) upon being cloned. In various implementations, the clone instruction can be an activation of a control associated with a virtual object, a gesture performed by a user in relation to a selected virtual object, a voice command performed in relation to a virtual object, etc.

A clone instruction can specify one or more of: how many clones to make, where to place clone virtual objects, and/or default values for cloned virtual object configuration settings. When not otherwise specified in the clone instruction, a clone operation can create one cloned object by default and can place the cloned virtual object(s) in spatial relation to source virtual object (e.g., dropped onto same surface as the source virtual object or placed a specified distance to the left or right of the source virtual object from the perspective of the creating user). Unless otherwise specified, the default value for the configuration setting(s) of the cloned virtual object can be copied from the source virtual object or the application that created the source virtual object can specify default configuration settings for cloned virtual objects (which can include logic, such as incrementing a counter into a list of values, so each clone receives the next value on the list for its configuration setting). In some implementations, the default configuration setting can be defined by a property mapping that takes, as a key to the mapping, a context of the source or cloned virtual object (e.g., what is around the virtual object, where the virtual object is placed, who cloned the virtual object, etc.) to return the corresponding configuration setting value. For example, a virtual object cloned onto a vertical surface can be mapped to configuration setting that causes it to display as a flat panel. As another example, a virtual object may be cloned through a clone instruction provided by a particular user with a home location set; and the mapping can take the location setting of the cloning user as its configuration setting.

At block 1504, process 1500 can clone the source virtual object, according to the clone instruction, into clone virtual object(s). This can include creating one or more “clones” of the source virtual object in the artificial reality environment, which may include making a copy of the source virtual object or making a call to the application that created the source virtual object, instructing it to make the cloned virtual object(s).

At block 1506, process 1500 can receive a configure instruction for the clone virtual object(s) and at block 1508, process 1500 can apply the configuration instruction to the clone virtual object(s). The configure instruction can specify one or more configuration settings for the cloned virtual object(s). In some cases, the configure instruction can have user manually specified values, e.g., specified through a user voice command, entered text, a gesture, selection from a list or other selection component, etc. In other implementations, the configure instruction can specify configuration setting values based on a paired element i.e., a virtual object (e.g., a virtual object dropped onto the cloned virtual object or vice versa), a surface (e.g., where clone virtual object is crated or dropped), or a volume that the clone virtual object is in. When the paired element has a variable of a type matching the type of a configuration setting of the clone virtual object, that variable can be used to set the configuration setting. For example, where the clone virtual object has a color configuration setting and a surface the clone virtual object is placed on has a color set, the clone virtual object color configuration setting can be copied form the surface color setting.

An input system can facilitate a page or peel input pattern by instantiating a virtual object, in an artificial reality environment, that has vertical and/or horizontal elements and receiving paging and/or peeling input from a user. In various cases, the elements of a virtual object can be from a pre-defined collection of virtual objects, such as the images in a photo album, the songs in a library, documents from a file, messages received in a messaging application, objects collected from a particular area, etc. In other cases, the virtual object's elements can be selected by a user, defined by the virtual object creator application when the virtual object is created, or through any other means of identifying a group of elements. The elements associated with a virtual object can be arranged in a two-dimensional grid of columns and rows. In some cases, each row can be a set of elements corresponding to a category defined for that row. For example, each image in an album can be organized into a category, with each photo category being represented by a row in the grid and each photo in a given category being arranged in the same row. In some implementations, the grid can be defined by a creator of the virtual object while in other cases the grid can be defined according to relationships among the elements, such as based on a defined hierarchy of categories into which the elements fall. In some implementations, the grid can have only a single row or a single column.

Once a virtual object with elements in a grid have been instantiated, inputs for vertical and/or horizontal paging can change which element is the “active” element for the virtual object. As used herein, the active element can be the one currently being displayed by the virtual object and the active element can control how the virtual object acts, such as how it performed interactions with other virtual objects, how it responds to user inputs, and the active element can be the one that is extracted when a peel operation is performed. In various implementations, paging inputs can be performed through activation of a UI control, a user gesture, a voice command, etc. Horizontal paging input can specify to switch the virtual object's active element to be the to the left or right of the current active element. In some cases, vertical paging input can specify to switch the virtual object's active element to be the one above or below a current active element while in other cases vertical paging input can switch to the row above or below the current row while selecting a different horizontal position in that row, such as the first element or the element that was last active in that row.

A peel input can extract the currently active element from a virtual object and make it available for other interactions in the artificial reality environment. For example, a user may perform a peel input by reaching into a source virtual object and performing a grab gesture on the active element, which the input system can respond to by putting an instance of the active element as attached to the user's hand (e.g., in the user's grasp). In various implementations, this can include removing the element from the source virtual object or making a copy of the element while leaving the original in the source virtual object. The user can then perform other actions with the element, such as dropping it into an open space or onto a surface to create a new virtual object based on the element or dropping the element onto another virtual object to perform an interaction between the element and the other virtual object.

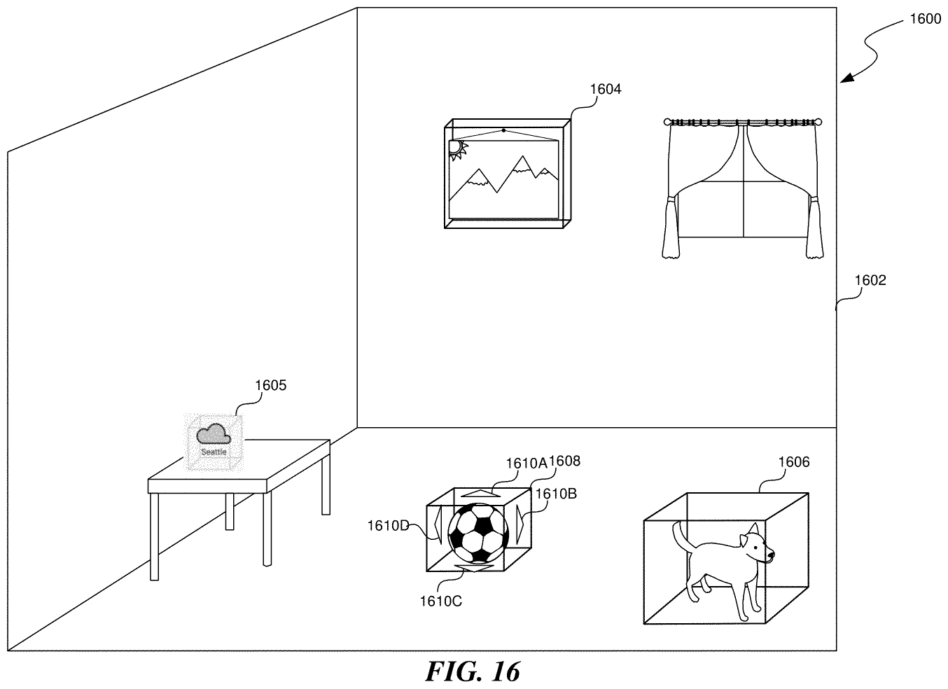

FIG. 16 is an example 1600 of an artificial reality environment with virtual objects, including one configured for a page or peel input pattern. Example 1600 includes an artificial reality environment 1602 displaying virtual objects 1604-1608. Virtual object 1608 is a virtual object configured for the page or peel input pattern, with affordances 1610A-1610D showing which ways the elements of virtual object 1608 can be paged and acting as controls that a user can activate to page between the elements.

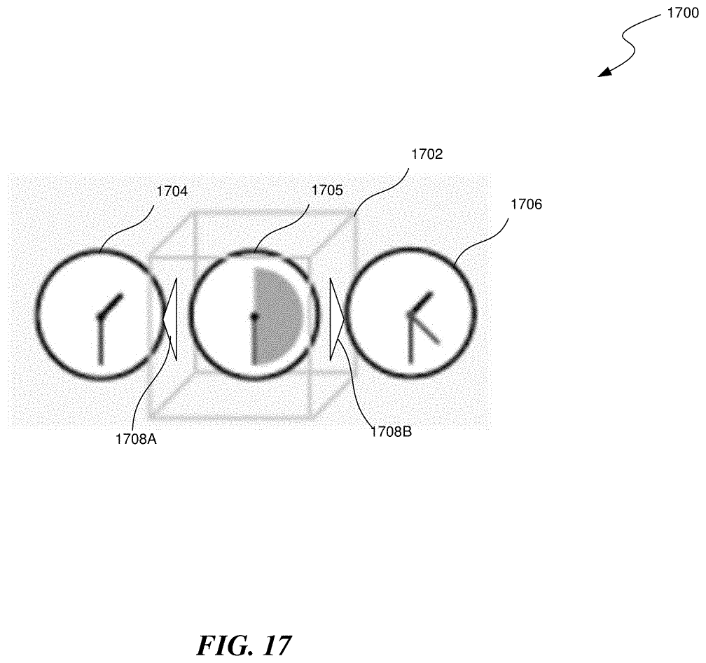

FIG. 17 is an example 1700 of a virtual object configured for a horizontal only page or peel input pattern. Example 1700 includes virtual object 1702 configured for the page or peel input pattern, with affordances 1708A and 17088 showing that the elements of virtual object 1702 can be paged horizontally, moving between elements 1704, 1705, and 1706 being the active element.

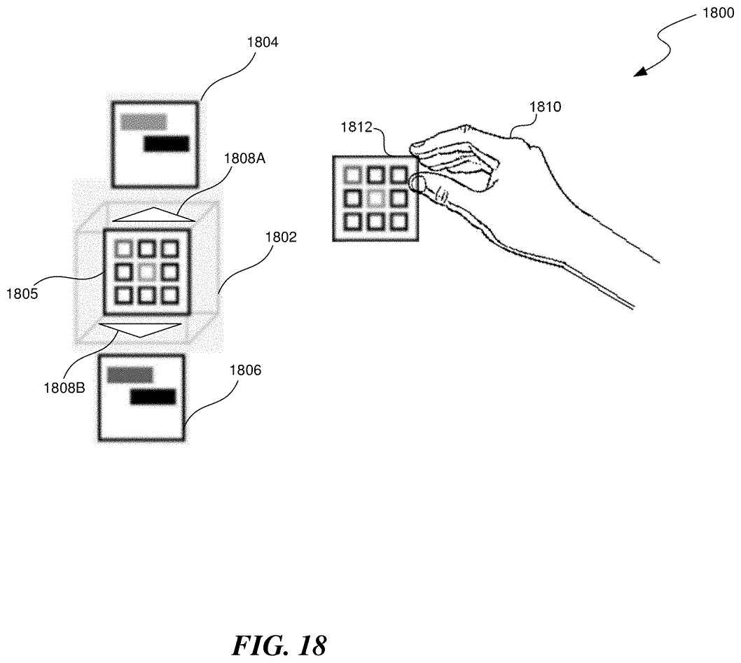

FIG. 18 is an example 1800 of a virtual object configured for a vertical only page or peel input pattern with a user performing a peel input. Example 1800 includes virtual object 1802 configured for the page or peel input pattern, with affordances 1808A and 18088 showing that the elements of virtual object 1802 can be paged vertically, moving between elements 1804, 1805, and 1806 being the active element. Example 1800 also illustrates a user 1810 having performed a grab gesture and peeled element 1805 out of the virtual object 1802, creating virtual object 1812, which the user 1810 can then drop to leave as a stand alone virtual object or can drop on another virtual object to perform an interaction.

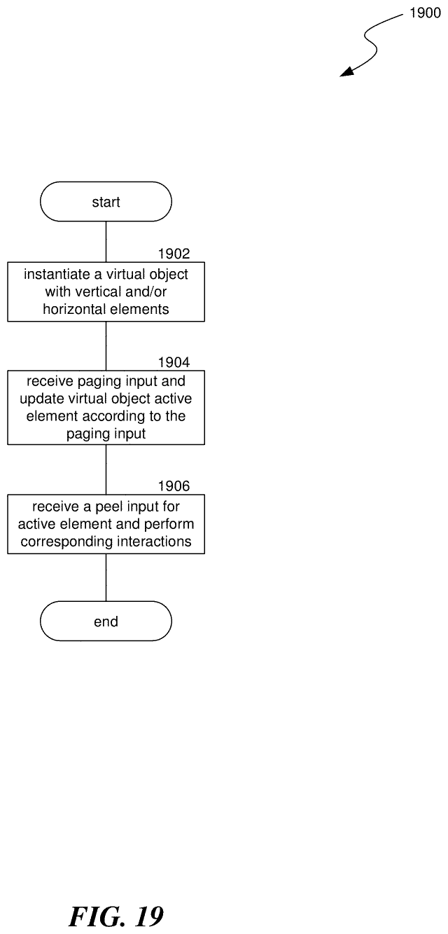

FIG. 19 is a flow diagram illustrating a process 1900 used in some implementations for performing a page or peel input pattern. Process 1900 can be performed by an artificial reality device in control of an artificial reality environment, e.g., as part of the operating system of the artificial reality device, a “shell” application under the operating system in control of the artificial reality environment, or as part of another application executed in an artificial reality environment.

At block 1902, process 1900 can instantiate a virtual object with vertical and/or horizontal elements. In various implementations, a virtual object can be defined to have vertical and/or horizontal elements by a creator of the virtual object or can be associated with a collection of elements, which process 1900 can automatically organize into a grid of vertical and/or horizontal elements. For example, the elements can have defined categories, topics, or a hierarchy, and process 1900 can define each row in the grid to correspond to a category, topic, or level of the hierarchy, and can organize the elements within each category, topic, or level of the hierarchy as the elements in that row. In some cases, the grid of elements of a virtual object may not be a rectangle, where some columns or rows can have less elements than other columns or rows. In some implementations, the virtual object can be instantiated to include visual affordances (e.g., arrows, shadows of adjacent elements, etc.) indicating that the virtual object can be paged between elements. In some cases, the visual affordances can also be UI controls that a user can activate to provide a paging input. In some implementations, the visual affordances can be dynamic, being shown only for the directions for which elements can be paged from the current active element. For example, if the elements are arranged in a rectangular grid and the current active element is the top left element, the virtual object may only include paging affordances for the right and downward directions as there are no elements above or to the right of the current active element.

At block 1904, process 1900 can receive a vertical or horizontal paging input and can update the virtual object active element according to the vertical or horizontal paging input. In various cases, the paging input can be provided by activation of a UI control (such as an affordance described in relation to block 1902), a gesture (e.g., horizontal or vertical swipe on the virtual object), a voice command, etc. In some implementations, paging between vertical rows A) can make activate the element in the next row in the same horizontal position as in the previous row, B) can activate an element in a first element position (e.g., the furthest left element in the new row), or C) process 1900 can track where the user was last time the user viewed the new row and can activate the same element (which can include using a default, such as one of version A) or B) when a user has not previously viewed a row, has not viewed a row within a threshold amount of time, or has not viewed a row since the current selection of the virtual object).

At block 1906, process 1900 can receive a peel input for an active virtual object element and can perform corresponding artificial reality environment interactions. A user can provide a peel input, in various implementations, by reaching into the virtual object to grab the current active element, by directing a ray at the current active element, through a voice command, by activating a peel UI control, etc. In various implementations, peeling an element out of a virtual object can either leave a copy of the element in the source virtual object or can remove the element from the collection of elements associated with the source virtual object. When an element is removed from the source virtual object's element collection, the source virtual object can transition to a next element as the active element. For example, the active element of the source virtual object can go to a next horizontal element to the left if any, then goes to next horizontal element to the right if any, then goes to next higher vertical element if any, and finally goes to next lower vertical element if any. Once a user has peeled out an element, the user may drop the element in an open volume or onto a surface with open space. This may cause process 1900 to create a new virtual object with just the peeled element or to create new virtual object with all the source virtual object's elements, but with the peeled element being the active element. The user may also drop the peeled element on to another virtual object, causing process 1900 to perform a combination action. Additional details on dropping one virtual object (or “augment”) onto another and resulting interactions are provided in U.S. patent application Ser. No. 17/131,563, titled Augment Orchestration, filed on Dec. 22, 2020, and incorporated herein by reference.

An input system can facilitate a clutter and clear input pattern by receiving a clutter input for a virtual object that has multiple elements, obtaining authorization to write into an expanded space of the virtual object, clearing other virtual objects from the expanded space and expanding the multiple elements of the virtual object into the expanded space (allowing for user interactions with the virtual object's elements), and upon a collapse command for the virtual object's elements, collapsing them back into the virtual object and restoring the other cleared virtual objects. In various cases, the elements of a virtual object can be from a pre-defined collection of virtual objects, such as the images in a photo album, the songs in a library, documents from a file, messages received in a messaging application, objects collected from a particular area, etc. In other cases, the virtual object's elements can be selected by a user, defined by the virtual object creator application when the virtual object is created, or through any other means of identifying a group of elements.

A virtual object can have a defined space that it was authorization to write into. When a clutter input is received for a source virtual object with multiple elements, the source virtual object can obtain authorization to “take over” an expanded space—either to create new virtual objects in the expanded space around itself or to expand its own space that it can write into. The input system (as part of the operating system of an artificial reality device, a “shell” application under the operating system in control of an artificial reality environment, or as part of another application executed in an artificial reality environment) can provide the authorization for the source virtual object to take over the expanded space. This can include the input system causing other virtual objects currently in the expanded space to be “cleared,” e.g., closed, hidden, reduced to a minimized form, moved out of the expanded space, and/or otherwise modified in display and/or position to make the expanded space available to the source virtual object. The source virtual object can then use the expanded space to create new virtual objects for its elements or to write representations of its elements into its expanded space—allowing the user to interact with the elements. Upon an explicit or inferred collapse command, the source virtual object's elements can be retracted back into the source virtual object, the expanded space can be released, and the other cleared virtual objects from the expanded space can be restored to their previous state and/or position.

As an example, a source virtual object representing a messaging service can be present in an artificial reality environment. A user can perform an explode gesture (e.g., grabbing the messaging virtual object with a five-finger pinch and then splaying all five fingers out) in relation to the messaging virtual object, causing the messaging virtual object to obtain authorization to take over a surface in the artificial reality environment that the messaging virtual object is on, minimizing each other virtual object on that surface to a small area in the lower corner of the surface. The messaging virtual object then expands its threads (the components of the messaging virtual object) as new individual virtual objects on the artificial reality environment surface. The user may pull out one of these thread virtual objects, expand it, send a message through the thread, etc. The user may then tap on one of the minimized virtual objects in the surface corner. The input system can interpret this as a collapse command for the messaging virtual object, causing the messaging virtual object to release the expanded space and pull the thread element virtual objects back into itself and causing the input system to restore the other virtual objects that were on the surface from their minimized state in the surface corner (selecting the one the user had tapped on).

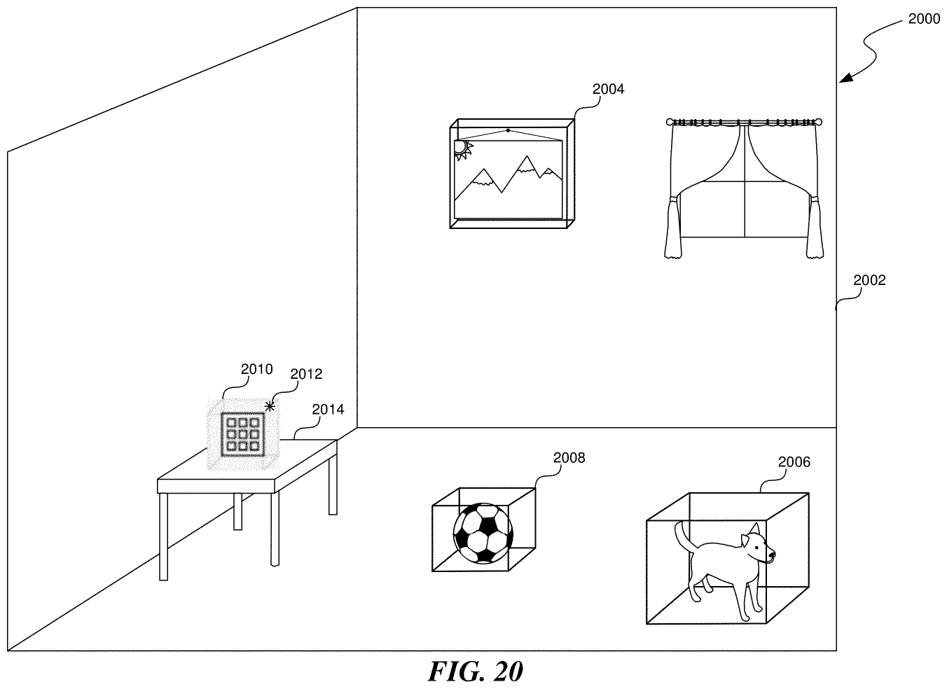

FIG. 20 is an example 2000 of an artificial reality environment with multiple virtual objects, one of which configured for a clutter and clear input pattern. Example 2000 includes an artificial reality environment 2002 displaying virtual objects 2004-2010. Virtual object 2010 is a virtual object configured for the clutter and clear input pattern, with affordance and UI control 2012, showing that virtual object 2010 can be expanded to show its elements on the surface of table 2014 and acting as a control to initiate this expansion.

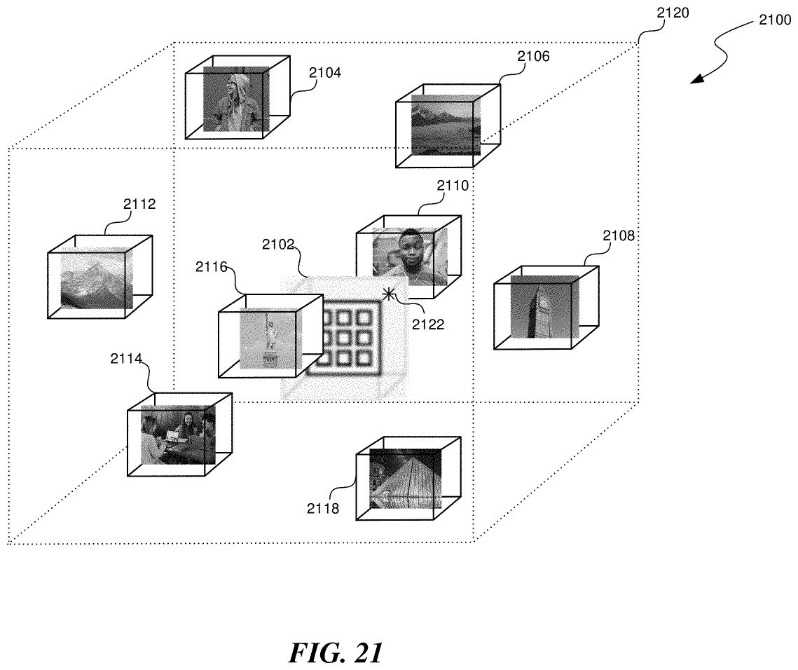

FIG. 21 is an example 2100 of a virtual object expanded to show its multiple elements through the takeover of a surrounding volume. In example 2100, a user has activated control 2122, causing the photo album virtual object 2102 to acquire authorization to write its photo elements into the volume 2120 (the outline of which may not be displayed in the artificial reality environment). Any virtual objects in the volume 2120 were hidden and the virtual object 2102 writes its photo elements 2104-2118 around itself in the volume 2120. In some cases, the virtual object 2102 may be hidden when its elements are expanded. This expansion allows the user to manipulate the elements 2104-2118. For example, the user could reach into the volume 2120 and perform a grab gesture on one of the elements, extracting it from the volume 2120 and putting it on a wall. This can cause the extracted element to remain in place when a collapse command is issued. In various implementations, extracting the element may remove it from the elements of the virtual object 2102 or may create a copy leaving the original in virtual object 2102's elements.

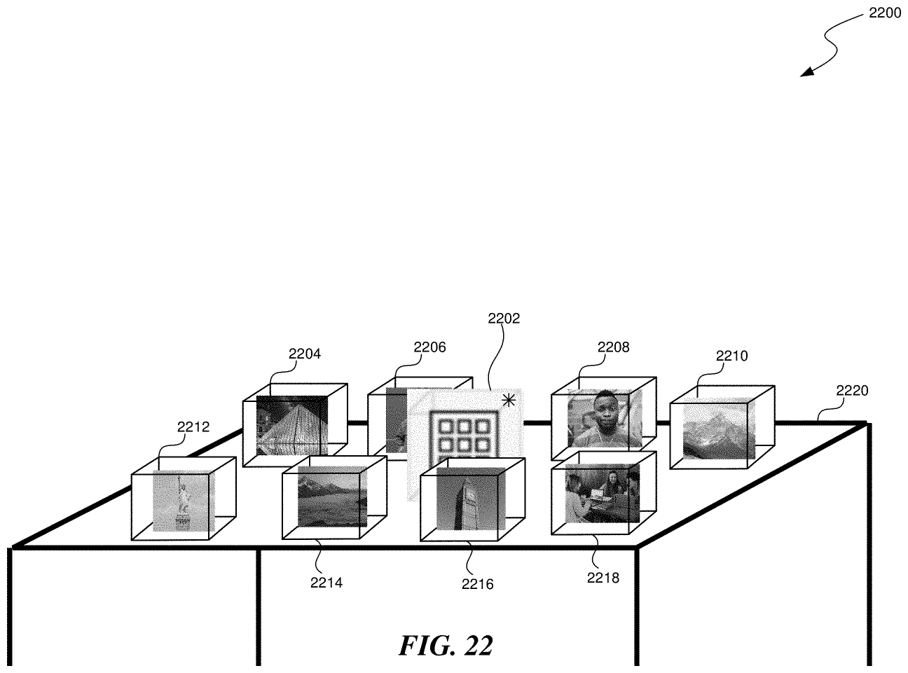

FIG. 22 is an example 2200 of a virtual object expanded to show its multiple elements through the takeover of a surface. In example 2200, a user performed a gesture corresponding to a clutter input, causing the photo album virtual object 2202 to acquire authorization to write its photo elements as new virtual objects into the surface 2220. Any virtual objects on the surface 2220 were hidden and the virtual object 2202 creates new virtual objects for its photo elements 2204-2218, placing them around itself on the surface 2220. In some cases, the virtual object 2202 may be hidden when its elements are expanded in this manner. This expansion allows the user to manipulate the elements 2204-2218. For example, the user could open photo element 2212 and crop and save it. This can cause the element 2212's new dimensions to persist when a collapse command is issued. In some implementations, if a user adds an element to the expanded area of a virtual object, that element is added to the elements of the virtual object, and is collapsed into the virtual object when a collapse command is issued for the virtual object.

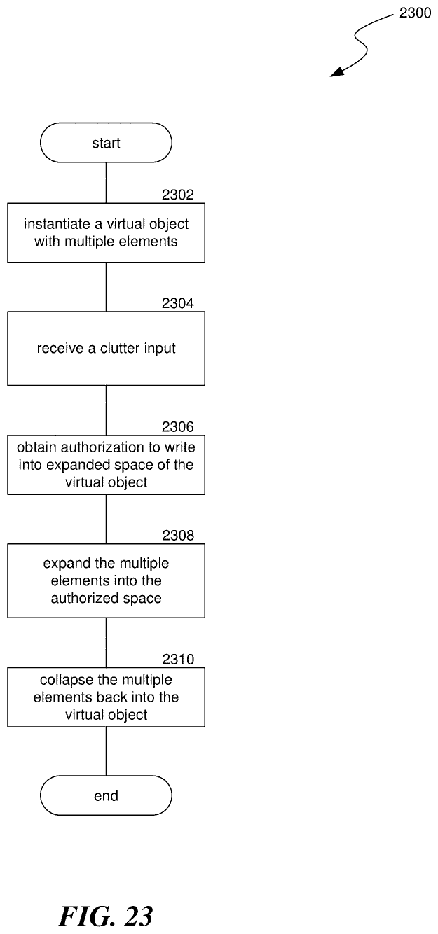

FIG. 23 is a flow diagram illustrating a process 2300 used in some implementations for performing a clutter and clear input pattern. Process 2300 can be performed by an artificial reality device in control of an artificial reality environment, e.g., as part of the operating system of the artificial reality device, a “shell” application under the operating system in control of the artificial reality environment, or as part of another application executed in an artificial reality environment.

At block 2302, process 2300 can instantiate a virtual object with multiple elements configured for the clutter and clear input pattern. A virtual object can have elements that have been added to it by a user, that are automatically added to it through predefined associations (e.g., where the virtual object represents a collection such as a photo album, a playlist, a social group, a conversation, or any other set of associated elements), or that a creating virtual object or application allocates as a collection. The virtual object can be added to a space in an artificial reality environment which, for example, can be a defined volume or a surface in the artificial reality environment.

At block 2304, process 2300 can receive a clutter input. A clutter input can be a signal associated with a source virtual object with multiple elements, indicating that the elements should be expanded out into the space around the source virtual object. In various implementations, a clutter input can be a user performing a gesture (such as an explode gesture) in relation to the source virtual object, selecting the source virtual object, activating a clutter UI for the source virtual object, providing a clutter voice command, or based on an inference such as a user's attention being on the source virtual object for a threshold amount of time.

At block 2306, process 2300 can obtain authorization to write into an expanded space of the source virtual object. If the source virtual object is on a surface in the artificial reality environment, the expanded space can be an expanded area of the surface, while if the source virtual object is floating in the artificial reality environment, the expanded area can be a volume around the location of the source virtual object. In some implementations, the expanded space can be a space around the source virtual object where the source virtual object causes additional virtual objects to be created for its constituent elements. In other implementations, the expanded space can be an expanded version of a space allocated to the source virtual object, allowing the source virtual object to display its constituent elements as components of itself.

The size of the expanded space can be based on a combined size of the elements of the source virtual object and/or the number of elements of the source virtual object. In some cases, the source virtual object's elements, when expanded, can be sized to fit within whatever expanded space the source virtual object is authorized to write into. Depending on amount of space needed for the source virtual object's constituent elements, the virtual object may takeover additional spaces beyond the one it was in/on. For example, an artificial reality environment can be organized in a hierarchy with each space (surface or volume) being a child element of another space, e.g., with a root space being an entire room. When a space takeover for expanding a source virtual object into its constituent elements requires more room than the space to which the source virtual object is allocated, the request can be passed up the hierarchy until a space is found that can support all the source virtual object's constituent elements. In some cases, when a source virtual object is allocated an expanded space, other virtual objects in that space can be cleared—such as by one or more of: removing them from the artificial reality environment, hiding them, minimizing their size, moving them to another area of the artificial reality environment, etc.

At block 2308, process 2300 can expand the multiple elements into the authorized space. When the expanded space is on a surface, the surface may have a defined layout into which the source virtual object's elements are arranged. When the expanded space is a volume or a surface without a layout, the source virtual object's elements can be arranged around the source virtual object, e.g., arranged equidistant from each other. In some cases the source virtual object is hidden when its elements are expanded; in other cases the source virtual object remains shown when its elements are expanded. While the source virtual object's elements are expanded, the elements can be interacted with such as allowing a user to select them, edit them, arrange them, add/remove elements from the collection of associated with the source virtual object, drop other virtual elements onto them, etc. In various implementations, pulling an element out of the expanded elements either removes the element from the elements of the virtual object or creates a copy of the element outside the collection while leaving the original in the virtual object's set of elements.

At block 2310, process 2300 can collapse the multiple elements back into the virtual object. Collapsing the elements can be in response to an explicit user collapse command (e.g., a gesture, activation of a UI control, a voice command, etc.) or in response to a collapse inference (e.g., when the user's attention is off the expanded space for threshold amount of time, when another virtual object that was cleared from the expanded space is authorized to take over the space or has another event to present, when the user doesn't interact with the virtual object's elements for a threshold time, etc.) Collapsing the multiple elements can also include the source virtual object releasing the expanded space, allowing the other virtual objects to be moved back into that space. This repopulation of the cleared virtual objects to the space can include restoring them to their previous view state and/or position.

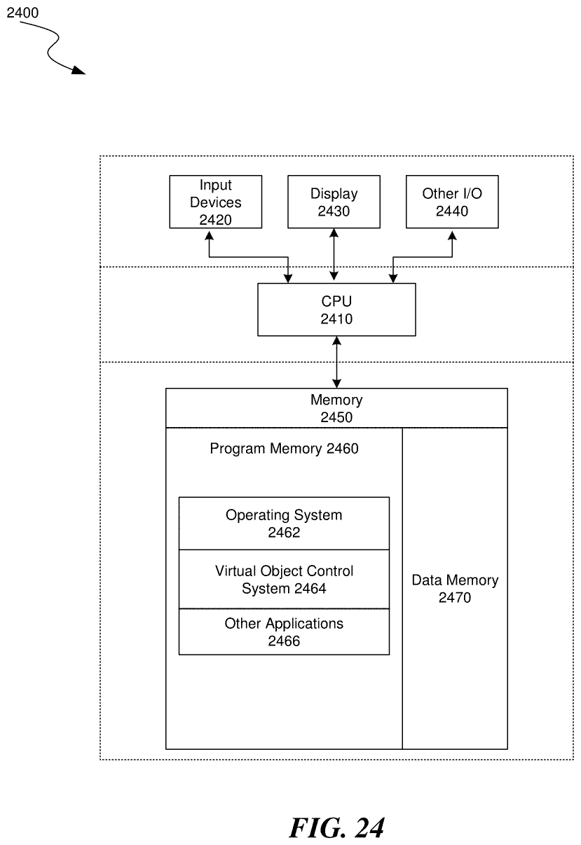

FIG. 24 is a block diagram illustrating an overview of devices on which some implementations of the disclosed technology can operate. The devices can comprise hardware components of a device 2400. In some cases, device 2400 can perform application controls in response to recognizing particular gestures. In some cases, device 2400 can provide a launcher with virtual objects displayed in categories such as a history of items the user has interacted with, pinned favorites, people the user has interacted with, and a search area. In some cases, device 2400 can perform a clone and configure input pattern, which clones a source virtual object into one or more cloned virtual objects with alternate configuration properties. In some cases, device 2400 can perform a page or peel input pattern, which A) displays a virtual object elements according to a grid, B) allows users to page between them to select an active element, and C) facilitates a peel operation to pull an instance of an active element out of the virtual object. In some cases, device 2400 can perform a clutter and clear input pattern, which can expand multiple elements from a virtual object into individual views of the elements in a space around the virtual object, while clearing the other virtual objects in that space. Device 2400 can include one or more input devices 2420 that provide input to the Processor(s) 2410 (e.g., CPU(s), GPU(s), HPU(s), etc.), notifying it of actions. The actions can be mediated by a hardware controller that interprets the signals received from the input device and communicates the information to the processors 2410 using a communication protocol. Input devices 2420 include, for example, a mouse, a keyboard, a touchscreen, an infrared sensor, a touchpad, a wearable input device, a camera- or image-based input device, a microphone, or other user input devices.

Processors 2410 can be a single processing unit or multiple processing units in a device or distributed across multiple devices. Processors 2410 can be coupled to other hardware devices, for example, with the use of a bus, such as a PCI bus or SCSI bus. The processors 2410 can communicate with a hardware controller for devices, such as for a display 2430. Display 2430 can be used to display text and graphics. In some implementations, display 2430 provides graphical and textual visual feedback to a user. In some implementations, display 2430 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2440 can also be coupled to the processor, such as a network card, video card, audio card, USB, firewire or other external device, camera, printer, speakers, CD-ROM drive, DVD drive, disk drive, or Blu-Ray device.

In some implementations, the device 2400 also includes a communication device capable of communicating wirelessly or wire-based with a network node. The communication device can communicate with another device or a server through a network using, for example, TCP/IP protocols. Device 2400 can utilize the communication device to distribute operations across multiple network devices.

The processors 2410 can have access to a memory 2450 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2450 can include program memory 2460 that stores programs and software, such as an operating system 2462, virtual object control system 2464, and other application programs 2466. Memory 2450 can also include data memory 2470, which can be provided to the program memory 2460 or any element of the device 2400.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

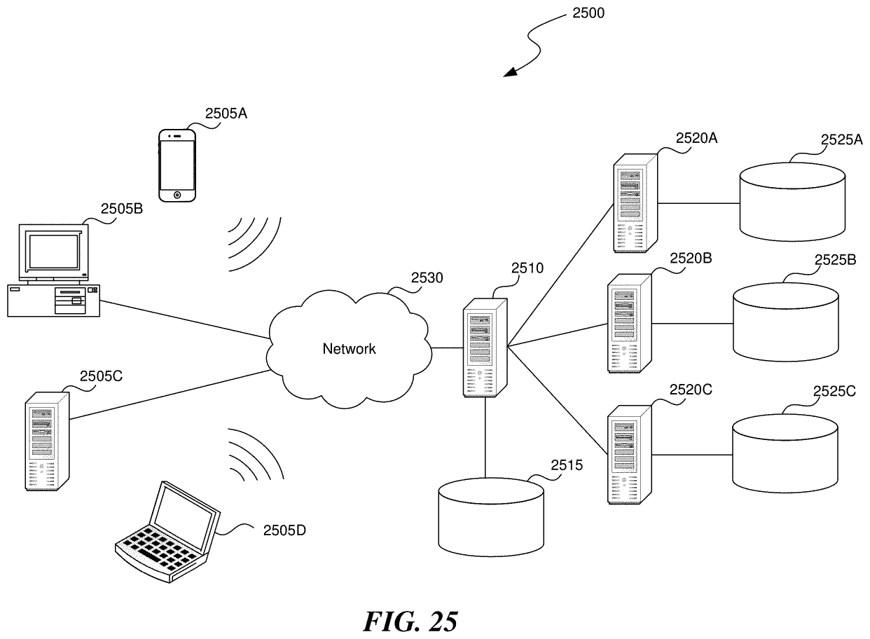

FIG. 25 is a block diagram illustrating an overview of an environment 2500 in which some implementations of the disclosed technology can operate. Environment 2500 can include one or more client computing devices 2505A-D, examples of which can include device 2400. Client computing devices 2505 can operate in a networked environment using logical connections through network 2530 to one or more remote computers, such as a server computing device.

In some implementations, server 2510 can be an edge server which receives client requests and coordinates fulfillment of those requests through other servers, such as servers 2520A-C. Server computing devices 2510 and 2520 can comprise computing systems, such as device 2400. Though each server computing device 2510 and 2520 is displayed logically as a single server, server computing devices can each be a distributed computing environment encompassing multiple computing devices located at the same or at geographically disparate physical locations. In some implementations, each server 2520 corresponds to a group of servers.

Client computing devices 2505 and server computing devices 2510 and 2520 can each act as a server or client to other server/client devices. Server 2510 can connect to a database 2515. Servers 2520A-C can each connect to a corresponding database 2525A-C. As discussed above, each server 2520 can correspond to a group of servers, and each of these servers can share a database or can have their own database. Databases 2515 and 2525 can warehouse (e.g., store) information. Though databases 2515 and 2525 are displayed logically as single units, databases 2515 and 2525 can each be a distributed computing environment encompassing multiple computing devices, can be located within their corresponding server, or can be located at the same or at geographically disparate physical locations.

Network 2530 can be a local area network (LAN) or a wide area network (WAN), but can also be other wired or wireless networks. Network 2530 may be the Internet or some other public or private network. Client computing devices 2505 can be connected to network 2530 through a network interface, such as by wired or wireless communication. While the connections between server 2510 and servers 2520 are shown as separate connections, these connections can be any kind of local, wide area, wired, or wireless network, including network 2530 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following: A method for performing a page or peel input pattern, the method comprising: instantiating a virtual object with vertical and/or horizontal elements, wherein the vertical and/or horizontal elements are arranged in a grid; receiving a paging input and updating which of the vertical and/or horizontal elements is an active element of the virtual object of according to the paging input; and receiving a peel input for the active element and performing a corresponding interaction. A method for performing a clutter and clear input pattern, the method comprising: receiving a clutter input for a virtual object, having an allocated space and multiple elements; obtaining authorization for the virtual object to write into an expanded version of the space, wherein obtaining the authorization causes one or more other virtual objects to be cleared from the authorized expanded version of the space; expanding the multiple elements as individual items into the authorized expanded version of the space; and in response to a collapse command or inference: causes the one or more other virtual objects to be returned to the expanded version of the space; and collapsing the multiple elements back into the virtual object. A computer-readable storage medium storing instructions that, when executed by a computing system, cause the computing system to perform a process comprising: receiving a clutter input for a virtual object, having an allocated space and multiple elements; expanding the multiple elements as individual items into an expanded version of the space; and in response to a collapse command or inference, collapsing the multiple elements back into the virtual object.

I/We claim:

1. A method for performing application controls in response to recognizing particular gestures, the method comprising:
recognizing a first pinch gesture;
determining whether the first pinch gesture is an index pinch or middle pinch; and
when the first pinch gesture is a middle pinch, toggling to a most recently active application; or
when the first pinch gesture is an index pinch:
in response to determining that the first pinch gesture has been pulled, where the pull is below a threshold distance and speed, activating an application switcher carousel; or
in response to determining that the first pinch gesture has been pulled, where the pull is above a threshold distance and speed, closing a currently active application.

2. A method for facilitating object interactions, in an artificial reality environment, with a launcher, the method comprising:
displaying a launcher in the artificial reality environment, wherein the launcher has two or more categories of items, the categories including at least a history of items related to user interactions in the artificial reality environment;
receiving a selection of an item in the launcher;
when the selection is in relation to a peel gesture, attaching a representation of the item to the user's hand making the peel gesture; and
when the selection is not in relation to a peel gesture, performing a selection action specified in relation to the selected item.

3. A method for performing a clone and configure input pattern, the method comprising:
receiving a cloneable source virtual object selection and a clone instruction for the source virtual object;
cloning, according to the clone instruction, the source virtual object into one or more cloned virtual objects;
receiving a configuration instruction for the one or more cloned virtual objects; and
applying the configuration instruction to the one or more cloned virtual objects.
